(19) United States
(12) Patent Application Publication
(10) Pub. No.: US 2023/0371530 A1
(43) Pub. Date: Nov. 23, 2023

(54) Hollow Ported Meat Cooling Probe

(71) Applicant: Rian Robert Wade Julian, San Martin, CA (US)

(72) Inventor: Rian Robert Wade Julian, San Martin, CA (US)

(21) Appl. No.: 18/201,154

(22) Filed: May 23, 2023

Related U.S. Application Data
(60) Provisional application No. 63/473,372, filed on May 23, 2022.

(51) Int. Cl. A22B 5/00

(52) U.S. Cl. CPC A22B 5/0076

(57) ABSTRACT

Probes for cooling meat include a hollow body having one or more openings and a hollow, pointed tip. The probes are inserted into the meat between the flesh and bone to create a space between the flesh and the bone. The heat stored within the bone may then be released through the hollow probe and into the environment. Some embodiments include a fan to increase air flow to the bone. Additionally, a carrying case for the probes is disclosed. The carrying case is hollow and includes an opening large enough to engage a probe, allowing the case to be used as a handle for easy insertion of the probe. Further, the carrying case can be mounted onto an archery bow and function as a stabilizer to reduce the gear a hunter must bring into the field.

### CROSS REFERENCE TO RELATED APPLICATIONS

This application claims the benefit of Provisional Application No. 63/473,372, filed May 23, 2022, which is incorporated by reference in its entirety.

### FIELD OF THE DISCLOSURE

The subject matter of the present disclosure refers generally to probes for releasing internal heat from meat, a carrying case for one or more probes, and a method for using the probes and case.

### BACKGROUND

Hunters face several challenges when attempting to take down game for its meat. One of these challenges is returning the meat of the animal out of the wilderness without the meat spoiling. After successfully taking down an animal, the meat immediately begins to spoil due to the animal's internal heat. This spoilage is often caused by the internal temperature of the animal being retained in the animal's bones and preventing the meat from cooling, thereby allowing bacteria to begin to multiply throughout the meat.

As is known in the art, heat flows from hot environments to cold environments in order to reach thermodynamic equilibrium. Barriers to heat transfer reduce the flow of heat from hot to cold environments and thus slow heat loss.

Traditionally, hunters field dressed meat to prevent blood from entering the meat and to allow the internal temperature to be released. Field dressing involves taking the quarters of a large animal, such as an elk, moose, or deer, and making a slice along the length of the quarter. This slice exposes the bone to the air to allow the heat stored in the bone of the meat to be released without having to pass through the rest of the flesh. While this can help to assist the heat loss, the cut must be held open by some means or else the cut will close when the meat is released. When the cut closes, the heat is again insulated in the bone.

Alternatively, some hunters will de-bone their meat immediately upon downing the game. The de-boned flesh is typically placed into a bag and then transported back for freezing or other preparation. This method does not allow the flesh to go through natural rigor mortis, which is an important step for retaining the meat quality. Further, although this method does prevent heat from the bone being steadily released into the meat, often times the bag filled with de-boned meat will retain more heat than the full quarter with the bone. As such, the de-boning method can be less effective than leaving the bone in the meat at reducing spoilage.

Thus, even with field dressing meat, spoilage still can occur due to the internal meat temperature being kept too high for too long. Therefore, there is a need in the art for a method and device to reduce the internal heat stored in game meat quickly and without removing the bone from the meat.

### SUMMARY

One aspect is a device for releasing the internal heat of game meat. The device comprises a hollow, ported probe with a conical tip that is inserted into the meat. The probe is generally spike shaped and is inserted into the length of the meat alongside the bone. Once inserted, the probe pulls the meat away from the bone and provides a minimal resistance route for heat to leave the bone. Thus, the heat stored in the bone flows out of the bone and into the void within the probe. The heat is then released into the environment, away from the meat.

The probe comprises a hollow cylindrical body having at least one opening extending through a sidewall of the probe, and preferably a plurality of openings disposed along a length of the probe. The openings further reduce the resistance for the heat transfer by providing direct air contact to the bone. The body then connects to a tip of the probe. The tip is tapered into a point to ease the insertion into the meat. The tip can also have at least one hole. In one embodiment, the tip is conical. In other embodiments, the tip can be a pyramid shape or be otherwise generally pointed.

Preferably, the tip is removably connected to the probe to allow for removal for cleaning. This removable connection can be a threaded connection, a snap fit connection, a locking pin and groove, or any other suitable connection method known in the art.

Preferably, the probe is made from a metal, such as aluminum or stainless steel. Alternatively, the probe can be made from plastic.

In some embodiments, the probe can be configured to attach to a hose or tube having a micro fan at the opposite end of the hose from the probe. The fan can be configured to expel air, promoting airflow and additional heat release through the probe. The micro fan can be battery powered. In some embodiments, the battery is solar powered to be able to be used in the wilderness away from reliable power sources.

The tube can be attached to the back of the probe by any selectively removable means. These means can include threads, grooves, protrusions, snap fit, locking pins, or any other appropriate method of selective attachment known in the art.

In another aspect, a carrying case for the probe is provided. The carrying case comprises a body having two ends and a removable cap on one end. In one embodiment, the carrying case can fit at least four probes inside its internal volume.

In some embodiments, the carrying case contains a hole in the middle of the case. The hole is configured to have a diameter that is larger than the exterior diameter of the probe. This allows the carrying case to be used as a handle to aid in inserting the probe into the meat. The user places the tip of the probe into the meat and then places the opposite end of the probe into the carrying case and can push on the case to drive the probe into the meat.

In some embodiments, the opposite end of the carrying case from the removable cap can be configured to have certain features. In one embodiment, the end of the case is configured to house a light to act as a flashlight.

In another embodiment, the opposite end of the carrying case is configured to be mounted onto a hunter's bow. In this embodiment, the carrying case with the probes acts as a stabilizer to steady the hunter's bow when the hunter draws it. The bow can be configured to have a mounting bracket such that the carrying case can be easily attached and removed as needed. This allows a hunter to reduce the amount of gear that is needed to be hauled into the field and thereby reduce the weight that must be carried.

Another aspect is a method of using the probe. In one embodiment, the method includes the steps of inserting the probe, as described above, into the meat. Further steps can include attaching a hose and fan to the probe to further accelerate the heat loss of the bone, as well as using the probe to hold the meat away from the bone to allow air to reach the bone. Additionally, the method can include inserting the back of the probe into the carrying case to use the carrying case as a handle to aid in inserting the probe into the meat. Still additional steps can include attaching the carrying case, with or without the probes inside, to a bow for use as a stabilizer.

### DESCRIPTION OF THE DRAWINGS

These and other features, aspects, and advantages of the present disclosure will become better understood with regard to the following description, appended claims, and accompanying drawings where:

FIG. 1 shows an embodiment of a hollow ported heat release probe embodying features consistent with the principles of the present disclosure.

FIG. 2 shows an embodiment of a probe having a removable tip embodying features consistent with the principles of the present disclosure.

FIG. 3 shows an embodiment of a probe consistent with the principles of the present disclosure.

FIG. 4 shows an embodiment of a probe including a fan and a tube consistent with the principles of the present disclosure.

FIG. 5 shows an embodiment of a carrying case that is consistent with the principles of the present disclosure.

FIG. 6 shows an embodiment of a carrying case that is consistent with the principles of the present disclosure.

FIG. 7 shows an embodiment of a carrying case that is consistent with the principles of the present disclosure.

FIG. 8 shows an embodiment of a carrying case configured to be used in conjunction with a hunting bow, consistent with the principles of the present disclosure.

### DETAILED DESCRIPTION

In the Summary above and in this Detailed Description, the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

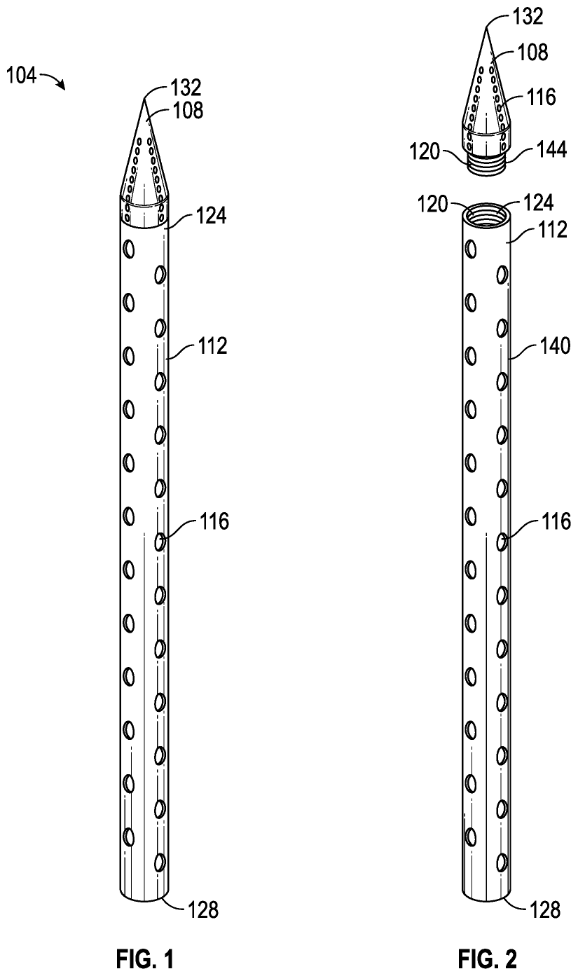

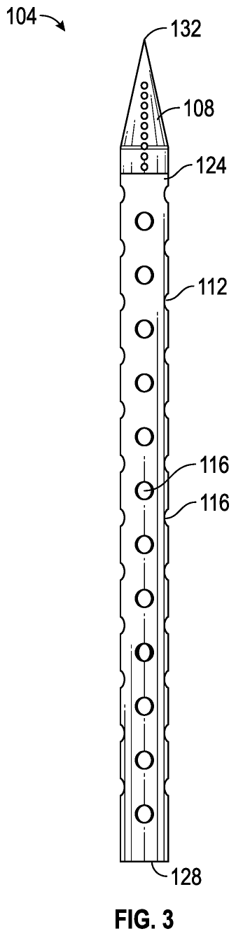

A probe 104 for releasing heat from game meat is disclosed. FIG. 1 shows an embodiment of the probe 104. The probe comprises a body 112, a tip 108, and a plurality of ports or openings 116. The body 112 has a front end 124 and a rear end 128. As shown, the body is generally cylindrical and hollow. Although the probe is depicted as being generally cylindrical, other shapes may be contemplated and still fall within the scope of the present disclosure. The body can be straight, like that shown in the figures, or can be tapered such that the entire probe is tapered towards a point.

The body comprises a sidewall 140 having several ports or openings 116. These openings allow the air to contact the bone directly and maximize heat transfer out of the bone. In some embodiments the openings are arranged in rows down the body of the probe. The rows of openings can be offset from each other along the body to maximize the area of the opening and reduce the surface area of the body. By reducing the surface area of the body, the heat transfer away from the meat is increased.

The tip 108 is tapered and ends in a point 132. The depicted embodiment of the tip is conical, but other configurations are contemplated, such as a pyramidal shape or an angled tip. Further, as with the body 112, the tip 108 can also be hollow and include openings 116 to increase heat transfer.

As shown by the embodiment in FIG. 2, the tip can be removable. Removing the tip allows a user to easily reach and clean the inside surface of the probe and the tip. In the depicted embodiments, the rear side of the tip can include a protrusion 144 that extends into the opening of the front end 124 of the body. Although the tip is shown to have threads 120 on this protrusion, other removable attachment means are contemplated, such as a locking ring, snap fit, groove and channel.

The front end 124 of the body is configured to accept the protrusion 144 of the tip. In the depicted embodiment, the interior of the tip contains threads 120 that engage the threads 120 of the tip 108. The protrusion 144 is then inserted into the opening and screwed in to attach the tip 108 to the body 112.

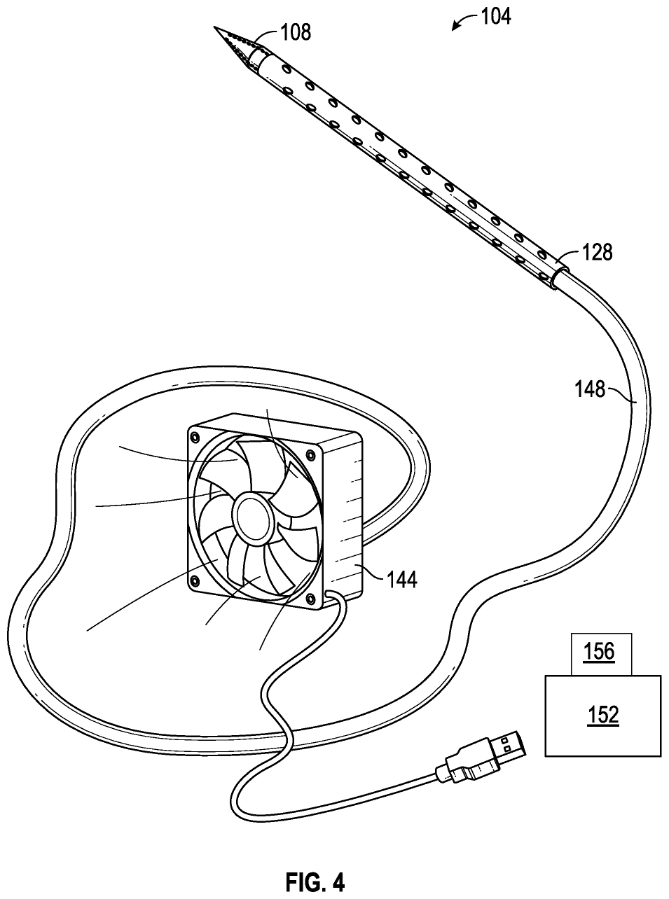

The rear end 128 of the body can be configured to interface with a fan 144. The fan increases the heat transfer by providing air flow through the probe 104. As shown in FIG. 4, the fan is configured to draw air from an interior of the probe and expel the air to the external environment, thereby increasing the rate of heat transfer from the meat to the external environment; however, the fan can also be configured to blow air into the probe to provide exterior air to the bone. Thus, the fan can be configured to increase airflow to or away from the bone, depending on the ambient air temperature.

In some embodiments, the fan interfaces with a tube 148. In these embodiments, the tube 148 connects to the rear end of the probe 128 and the fan 144. Although the fan is shown to be larger than the tube, the fan is preferably a micro fan and is sized to fit within the tube. Further, in some embodiments, the fan can be sized to fit within the rear end 128 of the body.

The tube 148 can be sized to be smaller than the rear end 128 of the probe such that one end of the tube fits inside the rear end of the probe 104. In these embodiments, the rear end of the probe can include features to secure the tube. These can include serrations or scallop features to increase friction. In some embodiments, the rear end 128 of the probe can include threads that interface with threads on an end of the tube 148. Alternatively, in other embodiments, the tube 148 can be larger than the rear end of the probe such that the probe fits inside an end of the tube.

In some embodiments, the fan 144 can be operated via a battery 152. The battery can include a solar panel 156 to provide electrical power to the battery. Alternatively, the battery 152 can be charged by traditional means.

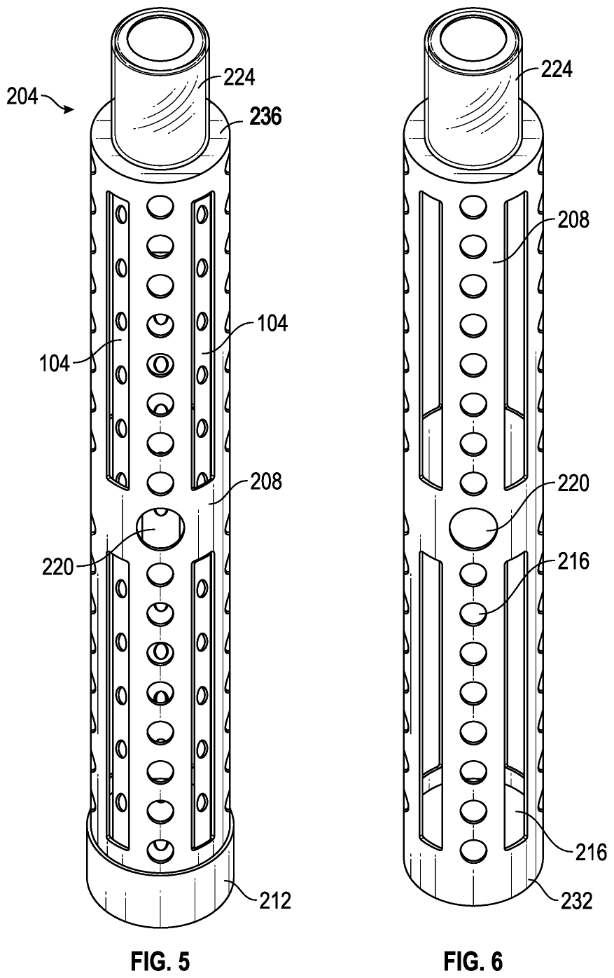

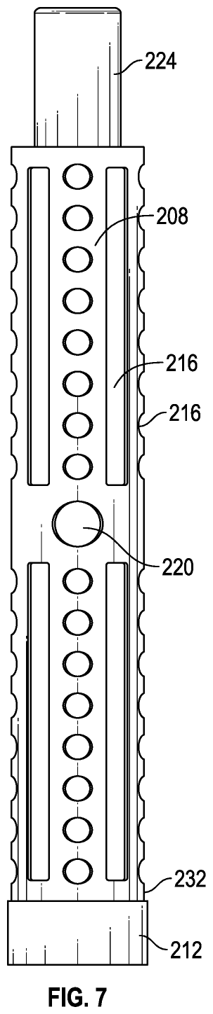

Another aspect is a carrying case 204. The carrying case 204 is hollow and can be generally cylindrical, such as the embodiment shown in FIG. 5. Further, the carrying case is comprised of a body 208, a front end 232, and a rear end 236.

A cap 212 can be removably attached to the front end 232 of the carrying case. The cap can be composed of any suitable material but is preferably made of plastic or rubber. The cap can be attached by friction or can have various attachment features, such as threads.

The rear end 236 of the body 208 is closed and can include an external protrusion 224. The protrusion extends away from the body 208. The front end 232, the rear end 236, and the body 208 collectively create an internal volume of the carrying case 204.

The carrying case has an internal volume that is large enough to accommodate at least one of the probes 104. As shown in FIG. 5, the carrying case 204 can store a number of probes 104 inside the body 208. In preferred embodiments, the carrying case is large enough to hold at least four of the probes 104.

The body 208 can contain openings 216 along the sides. The openings 216 can be of various shapes and sizes. The embodiment shown in the figures contains both rectangular and circular openings 216. These openings 216 are intended to reduce the weight of the carrying case by reducing the amount of material present in the body 208. The openings 216 can be displaced in rows along the sides of the body 208.

In addition to openings 216, the carrying case can include a single insertion port 220 that has a diameter that is larger than a diameter of the probe 104. The insertion port 220 is larger than the openings 216. The opposite side of the body from the insertion port 220 is solid and does not contain an opening 216 or an insertion port. This allows the carrying case to be used as a handle for inserting probes into meat. The insertion port 220 is positioned generally approximately halfway along the length of the body 208.

When the carrying case 204 is used to insert the probe 104 into the meat, the probe is positioned with the rear end 128 of the probe in the insertion port 220. The probe 104 extends into the insertion port 220 and contacts the opposite sidewall of the body 208 from the insertion port such that the probe is perpendicular with the carrying case with the tip 108 pointed away from the case and towards the meat. When the user presses the carrying case 204 into the probe, the sidewall transfers force into the probe 104 which is then inserted into the meat of the animal. This allows the user to push the probe using both hands on the carrying case 204, one on each side of the insertion port 220.

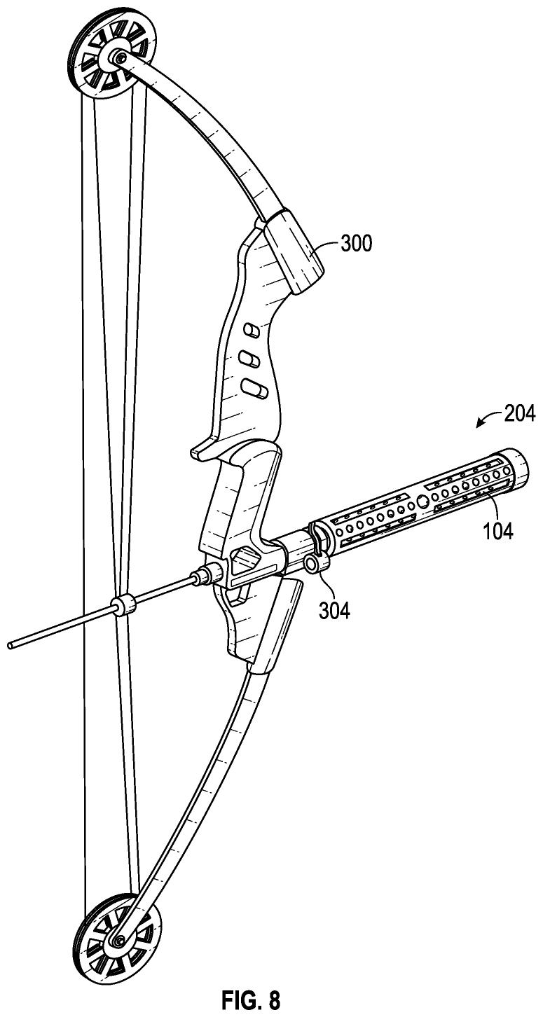

The protrusion 224 can be configured to include additional functions. In one embodiment, such as the one shown in FIG. 8, the protrusion 224 can be configured to attach to a front end of an archery or hunting bow 300. As shown, the protrusion 224 is configured to be removably attached to a bracket 304 on the bow 300. The bracket is configured such that the case 204 extends forward away from the archer. This allows the carrying case 204 to be used as a stabilizer for the bow 300 while storing probes 104. Thus, a hunter can replace some of their traditional gear with the carrying case and the probes in order to avoid using additional space or increasing the weight that must be carried into the field.

In alternative embodiments, the protrusion 224 can include other functions. In some embodiments, the protrusion can include a light to allow the case to be used as a lamp or a flashlight.

Another aspect is a method of using the probes and the carrying case. Specifically, the method can include the following steps. First, a device comprising a probe as discussed in this disclosure is provided. The probe can be hollow and contain a pointed front end or tapered tip. The probe can be generally cylindrical and may contain openings or ports in the sidewall of the probe body.

Next, a probe is inserted into the meat of a game animal. The probe is inserted into the meat between the flesh of the meat and the bone. This allows the meat to be pulled away from the bone and allow the bone to be exposed to air. The internal heat from the bone is then transferred from the bone to the air in the probe prior to being transferred into the environment.

Additionally, a fan 144 can be used in conjunction with the probe 104. In some embodiments, the fan can be attached to a rear end 128 of the probe 104. The fan 144 is configured to blow air away from the probe 104 and into the environment. By attaching a fan to the rear end 128 of the body of the probe 104, airflow increases the rate of heat transfer from the meat and into the environment.

Further, a hose or tube 148 can be attached to the rear end 128 of the probe body and the fan 144. This allows for air to flow from the probe and into the tube caused by suction generated from the fan.

In some embodiments, the method includes removing the tip 108 and placing the probe 104 into a cut or slit made in the meat of the animal. The body 112 of the probe 104 is used to hold the cut in the meat open and allow the exterior air to contact the bone of the meat through the openings 116 in the body of the probe. This allows the internal heat in the bone to be released into the environment through the hollow space in the body 112 of the probe.

In some embodiments of the method, a carrying case 204 is also provided. The carrying case 204 is comprised of a body 208, a front end 232, a rear end 236, and a cap 212, which define an internal volume. The internal volume of the carrying case 204 is configured to accommodate a probe 104. Preferably, the carrying case can accommodate at least four probes 104. In some embodiments, the carrying case includes a series of openings or ports 216. Some embodiments also include a single insertion port 220 that has a diameter that is larger than an external diameter of the probe 104.

Further steps include placing a rear end 128 of a probe 104 into the larger port 220 and applying force to the probe 104 via the case 204. This allows a user to use the carrying case 204 as a handle to insert the probe into the animal meat.

Additional steps include attaching the carrying case 204 to a hunting or archery bow 300. The bow can be provided with a bracket 304 to accept a protrusion 224 of the carrying case 204. When the protrusion 224 is engaged with the bracket 304, the carrying case 204 extends away from the bow and the user such that the carrying case acts as a stabilizer for the bow.

In further embodiments, the carrying case 204 is attached to the bow 300 with one or more probes 104 inside the carrying case.

Another aspect of the disclosure is a system including a probe 104 and a carrying case 204. The probe 104 can be configured to interface with a fan and a tube to increase air flow to the meat, thus increasing the heat that is removed from the meat. The system can further include a carrying case 204. The system can additionally include a bow that is configured to be attached to the carrying case 204 via a bracket 304 such that the carrying case extends away from the bow string and the archer. This allows the carrying case to act as a stabilizer for said bow.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter can be made without departing from the principles and scope of the inventive subject matter.

What is claimed is:

1. A method of releasing internal heat from meat, comprising the following steps:
providing a probe;
wherein said probe comprises an elongated, hollow body having a first end and a second end and wherein the first end has a pointed tip and the second end is open;
wherein there is an opening extending through a sidewall of said body;
inserting a probe into flesh of meat; and
wherein body heat stored in said flesh flows from said flesh to an external environment via said probe.

2. The method of claim 1, further comprising the steps of attaching a micro fan to the second end of said probe, wherein said fan blows air away from said first end of said probe.

3. The method of claim 2, further comprising the steps of attaching a first end of a tube to the second end of said probe; wherein said second end of said probe is opposite said tip.

4. The method of claim 1, further comprising the steps of:
removing the tip from the body of the probe prior to inserting the probe into the meat;
wherein the probe is inserted into a cut in the flesh of the meat such that the body of said probe is between opposite sides of the cut and wherein a bone of said meat is exposed to air via said opening in said sidewall of said probe.

5. The method of claim 1, further comprising the steps of:
providing a carrying case, said carrying case comprising a front end, a back end, and a hollow body;
said hollow body being sized to hold a plurality of probes; and
storing a probe in said carrying case before inserting said probe into said meat.

6. The method of claim 5, further comprising the steps of:
wherein the carrying case further comprises an insertion port, said insertion port having a diameter that is larger than an exterior diameter of said body of said probe;
inserting a rear end of said probe into said insertion port of said carrying case; and
using said carrying case as a handle to insert said probe into said flesh of said game meat.

7. The method of claim 5, further comprising the steps of:
providing an archery bow having a bracket configured to be removably attached to said back end of said carrying case;
attaching said back end of said carrying case to said bracket such that the front end of said carrying case extends away from a string of said bow.

8. A system for removing heat from game meat, said system comprising:
a carrying case;
said carrying case having a hollow body, a first end, and a second end, defining an internal volume;
said body of said case having a sidewall having a first opening; and
said first end having a removably attachable cap;
a plurality of probes;
each of said probes having a hollow body and a hollow tip; and
said body of said probe having an opening in a sidewall of said body.

9. The system of claim 8, wherein said carrying case is sized to hold the plurality of said probes.

10. The system of claim 8, wherein said first opening of said carrying case has a diameter that is larger than an external diameter of said probes and the sidewall opposite of said first opening does not contain an opening.

11. The system of claim 8, further comprising:
an archery bow having a bracket;
said bracket configured to be removably attached to said second end of said carrying case; and
wherein when said storage case is attached to said bracket, said storage case extends away from a string of said archery bow.

12. The system of claim 8, further comprising:
a tube having a first end, a second end, and an external diameter;
said external diameter of said tube being approximately equal to an internal diameter of said probe; and
said first end of said tube being removably attached to a second end of said probe;
said second end of said probe being opposite said tip of said probe.

13. The system of claim 12, further comprising a micro fan configured to be attached to a second end of said tube.

14. The system of claim 13, wherein the micro fan is configured to blow air away from said probe.

15. The system of claim 8, further comprising a micro fan that is configured to be attached to a rear end of said probe and provide air flow to said probe.

16. An apparatus for removing heat from animal flesh, comprising:
a probe having a hollow body and a pointed tip;
said body having a first end and a second end;
said first end connected to said tip;
said second end having an opening having a first diameter;
a fan being attached to said second end of said body and configured to blow air away from said first end of said body.

17. The apparatus of claim 16, further comprising:
a tube having a first end and a second end;
said first end connected to said second end of said probe;
said second end connected to said fan such that said fan blows air away from said tube.

18. The apparatus of claim 16, wherein said body has a plurality of openings on a sidewall.

19. The apparatus of claim 16, wherein the first end of said body is removably attached to said tip.

20. The apparatus of claim 16, wherein said tip of said body is conical and has a threaded protrusion;
wherein said first end of said body contains threads on an inner surface of said first end; and
wherein the threads on the inner surface of said first end engage said threaded protrusion.
